(19) United States
(12) Patent Application Publication
(10) Pub. No.: US 2011/0154293 A1
(43) Pub. Date: Jun. 23, 2011

(54) SYSTEM AND METHOD TO IDENTIFY PRODUCT USABILITY

(75) Inventors: Pallavi Dharwada, Minneapolis, MN (US); Anand Tharanathan, Plymouth, MN (US); John R. Hajdukiewicz, Florham Park, NJ (US)

(73) Assignee: Honeywell International Inc., Morristown, NJ (US)

(21) Appl. No.: 12/641,098

(22) Filed: Dec. 17, 2009

(51) Int. Cl. G06F 3/048; G06F 11/36

(52) U.S. Cl. 717/125

(57) ABSTRACT

A data entry device is provided to enter data related to usability of a user interface of a product. A processor provides a usability score card on the data entry device. The score card facilitates entry of usability issues regarding the user interface, and entry of data related to three dimensions of each issue including a risk severity, a probability of occurrence of the issue, and a probability of detecting the issue. The processor processes the data to provide an overall usability score of the user interface.

### BACKGROUND

Usability evaluation methods currently deployed by product development teams help in reporting an issue log and only provide a very subjective indication of the usability. This does not allow the product development teams and the management to objectively track the level of improvement of the usability and does not provide a directional indication with respect to usability improvement across various design and development iterations or cycles. There is no scoring system that provides an objective indication of the overall usability level. The score card tool is an objective method to evaluate the usability of products while being able to measure and track the quality of a product and/or process over a period of time. Further this is a decision-making tool that provides guidance on problem areas that need immediate attention as well as those that pay off more.

### BRIEF DESCRIPTION OF THE DRAWINGS

FIG. 1 is a diagram on an example interface for providing information about an issue associated with a product user interface according to an example embodiment.

FIG. 2 is a diagram of an example interface 200 showing an issue log according to an example embodiment.

FIG. 3 is a diagram of an example administrator interface providing search options to find projects, iterations, build numbers, issue status, usability area, and user heuristic according to an example embodiment.

FIG. 4 is a diagram of a chart that illustrates scores at various stages of development according to an example embodiment.

FIG. 5 is an illustration of a dashboard view that shows a current score for each area and each heuristic according to an example embodiment.

FIG. 6 illustrates a table having scores for a hypothetical product interface according to an example embodiment.

FIGS. 7A, 7B and 7C illustrate a table showing scores for issues and intermediate calculation values along with final scores according to an example embodiment.

FIG. 8 is a block diagram of an example system for executing programming for performing algorithms and providing interfaces according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

The functions or algorithms described herein may be implemented in software or a combination of software and human implemented procedures in one embodiment. The software may consist of computer executable instructions stored on computer readable media such as memory or other type of storage devices. Further, such functions correspond to modules, which are software, hardware, firmware or any combination thereof. Multiple functions may be performed in one or more modules as desired, and the embodiments described are merely examples. The software may be executed on a digital signal processor, ASIC, microprocessor, or other type of processor operating on a computer system, such as a personal computer, server or other computer system.

Heuristic evaluation is a commonly used technique that helps to identify usability issues in a product at different stages of its development lifecycle. Although there are pros to using this technique, there are several limitations in its current form. Currently, there is no scoring system that provides an objective indication of the overall usability level.

A score card tool and corresponding system is described herein. In some embodiments, the system provides an objective method to evaluate the usability of products while being able to measure and track the quality of a product and/or process over a period of time. The score card tool is a decision-making tool that provides guidance on problem areas that need immediate attention as well as those that pay off more.

The score card tool incorporates one or more of the following aspects:

1. Takes an objective approach to heuristic evaluation and hence, reduces the extent of subjectivity involved in its current form.

2. Uses a quantitative evaluation mechanism to compute an overall usability score that is sensitive to the number of heuristic violations and the severity of such violations in a product.

3. Helps to measure and track the quality of a process across iterations in a product's lifecycle.

4. Works as a decision-making tool that provides guidance on problem areas to focus and priority to maximize operational benefits.

5. Categorizes the results of the usability heuristic evaluation on a scale of Low to High level of Usability.

6. Apart from being able to evaluate the usability of a product, this tool should be flexible enough to evaluate the quality and/or efficiency of other processes (e.g., overall performance, cost etc).

The score card tool takes an objective approach to heuristic evaluation. Previously, a heuristic evaluation did not provide a rank or a score. Instead, it simply listed the violated heuristics, the risk of such violations, and solutions to the same. The score card tool in one embodiment provides an output that is a number that ranges from 1 to 100 and is representative of the overall usability of the user interface for a product. This number is calculated based on mathematical algorithms that help to quantify the number of violated heuristics and the risk of such violations.

The score card tool uses a quantitative evaluation mechanism to compute an overall usability score that is sensitive to the number of heuristic violations and the severity of such violations in a product. In its current form, a heuristic evaluation simply lists the violated heuristics, the risk of such violations, and solutions to the same. This limitation is resolved by using mathematical algorithms that help to compute a final score, while being sensitive to the number of violated usability heuristics, the risk level, frequency, and detectability of such violations.

More specifically, the mathematical algorithms have the following characteristics. The score card allows to categorize the usability issues into usability areas, and within each usability area, there are specific usability heuristics. Each violation is listed under the respective usability heuristic and a rating (for example: 1, 3 or 9) is provided along three dimensions—risk, probability of detection and probability of occurrence. As the number of heuristic violations under each usability area increases, the overall score for that usability area decreases. As the severity score of a heuristic violation increases, the overall score for that usability area decreases. In one embodiment, the mean of the scores of the usability areas is the final usability score.

The system helps to measure and track the quality of a process across iterations in a product's lifecycle. Usability evaluation is an iterative process that needs to be executed at different stages of a product's lifecycle. For example, within a development cycle, a product typically goes through several iterations. Currently, there are no standard methods that help to assess usability across iterations, and ones that logically display the results of the same. The system enables one to evaluate the usability of a product at different stages of its development cycle, and to maintain a repository that helps to graphically and quantitatively display the usability scores across iterations. Such a mechanism helps developers, upper management and usability evaluators to assess the progress in usability of a product across iterations and consequently helps to hone in on specific problem areas.

The score card tool is a decision-making tool that provides guidance on problem areas to focus, and priority to maximize operational benefits. A low score for a specific usability area indicates that the product has significant violations or problems in that usability area and brings them to the developers attention and helps them in prioritization.

Results of the usability heuristic evaluation may be categorized on a scale of Low to High level of Usability. The final usability score may be categorized qualitatively as a poor or good score. A coloring mechanism (ranging from green to red) may be used to indicate the severity of the final usability score. The stage of the product's lifecycle (early versus late) may have a bearing on how the usability score is categorized (low versus high). A relatively lower score early on in the product's lifecycle would be categorized as less severe (e.g., yellow color) while the same score later on in the product's lifecycle would be categorized as highly severe (e.g., red color). This categorization particularly provides more flexibility to developers early on.

Before starting the evaluation, a usability expert identifies appropriate usability areas, and the usability heuristics within those areas. Example areas may include access, content, functionality, organization, navigation, system responsiveness, user control and freedom, user guidance and workflow support, terminology and visual design.

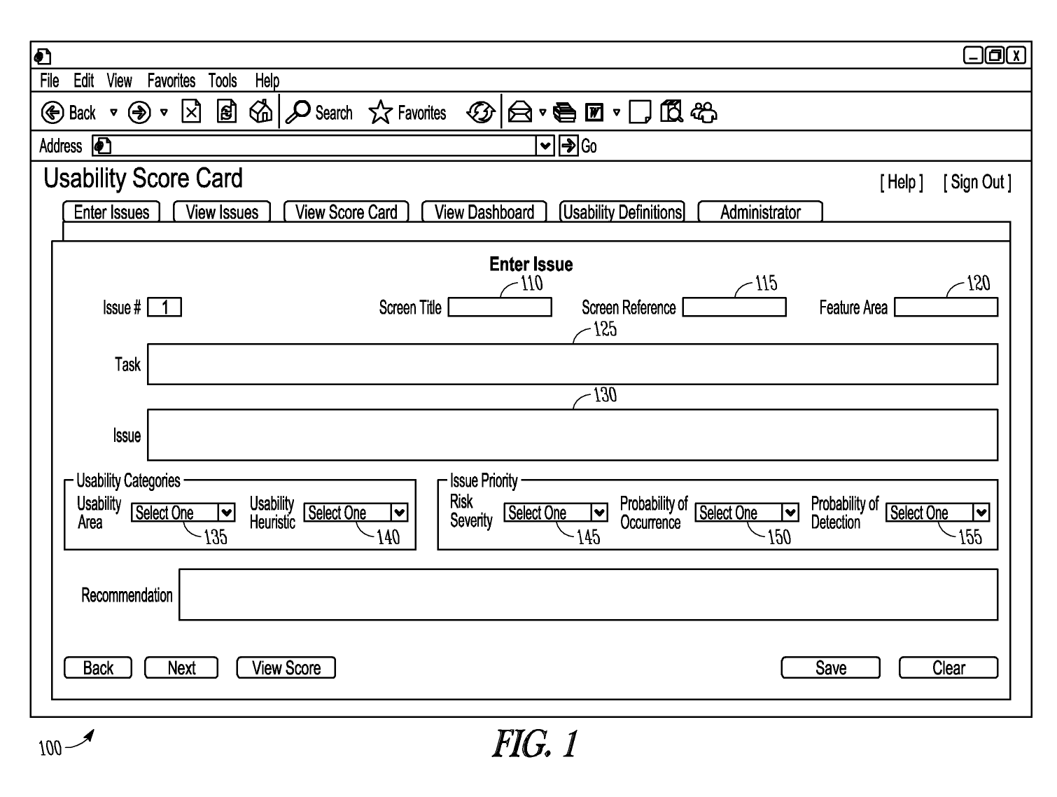

FIG. 1 shows an example user interface 100 for entering information about a particular issue associated with a user interface. The interface provides constructs to identify the issue and its relationship to the overall user interface, such as identifying a screen 110, screen reference 115, featured area of the screen 120, task 125, and a description of the issue 130. It also provides for entry of the usability area 135 and a usability heuristic 140 associated with the usability area. The example user interface also provides for entry of scores for each of the dimensions; risk severity 145, probability of occurrence 150, and probability of detection 155.

The usability expert then identifies and documents aspects of a product that violate specific usability areas and the nested heuristics within the usability areas via the user interface 100, or other type of user interface, such as a spreadsheet, or other interface suitable for entering data having various different look and feels. These identified aspects are labeled as findings. Each finding is rated along three different dimensions (a) the risk associated with the finding (b) the probability of its occurrence (c) the probability of detecting the finding. A rating of 1, 3 or 9 is given along these three dimensions. A rating of 1 is considered as a minor irritant, 3 is considered as a major issue and 9 is considered as a show stopper.

The usability expert also can record additional notes for each finding that he or she sees as beneficial for retrospective review. As the usability expert records and rates findings a mathematical algorithm automatically calculates a score ranging from 1 to 100, for each usability area. The algorithm may be written in such a way that the score would be higher if there are relatively less number of findings that have lower ratings (e.g., 1). In contrast, the score would be lower if there are relatively more number of findings that have higher ratings (e.g., 9).

Then, the average score of all the usability areas is computed, and labeled the final usability score of the product. Depending on the lifecycle stage of the product, the usability score is categorized from poor to good. An example algorithm for performing the calculations is shown as follows:

nᵢ=Total number of violations or issues per heuristicᵢ

xᵢ=total number of risk ratings that equal a value of 9 across the three risk dimensions (risk severity, occurrence, and detectability) on all the issues identified for heuristicᵢ

yᵢ=total number of risk ratings that equal a value of 3 across the three risk dimensions (risk severity, occurrence, and detectability) on all the issues identified for heuristicᵢ

zᵢ=total number of risk ratings that equal a value of 9 across the 3 risk dimensions (risk severity, occurrence, and detectability) on all the issues identified for heuristicᵢ

Proportion for heuristic, Pₕᵢ=(x*9*0.6+y*3*0.3+z*1*0.1)/nᵢ

Score per heuristic Sₕᵢ=(1−Pₕᵢ)m

where m=nᵢ/3, if nᵢ=1 or 2

m=nᵢ/2.75, if nᵢ=3 or 4;

m=nᵢ/2.5, if nᵢ=5 or nᵢ=6;

m=nᵢ/2.25, if nᵢ=7 or nᵢ=8;

m=nᵢ/2, if nᵢ=9 or nᵢ=10;

m=nᵢ/1.5, if nᵢ>10

Proportion for Area, Pₐᵢ=((Σxᵢ₌₁_{_{→}}₁)*9*0.6+(Σyⱼ₌₁_{_{→}}ₘ)*3*0.3+(Σzₖ₌₁_{_{→}}ₙ)*1*0.1)/nᵢ

Score per Area Sₐᵢ=(1−Pₐᵢ)^{m}

Percentage Score, PSaᵢ%=Saᵢ*100

Defect Rate/Defect Density, d=Total number of screens/Total number of findings

If d>=1, Overall Score=PSₐᵢ

Adjusted defect density ratio Ad=d/1.75,

If d<1, Overall Score=(PSₐᵢ/Ad)

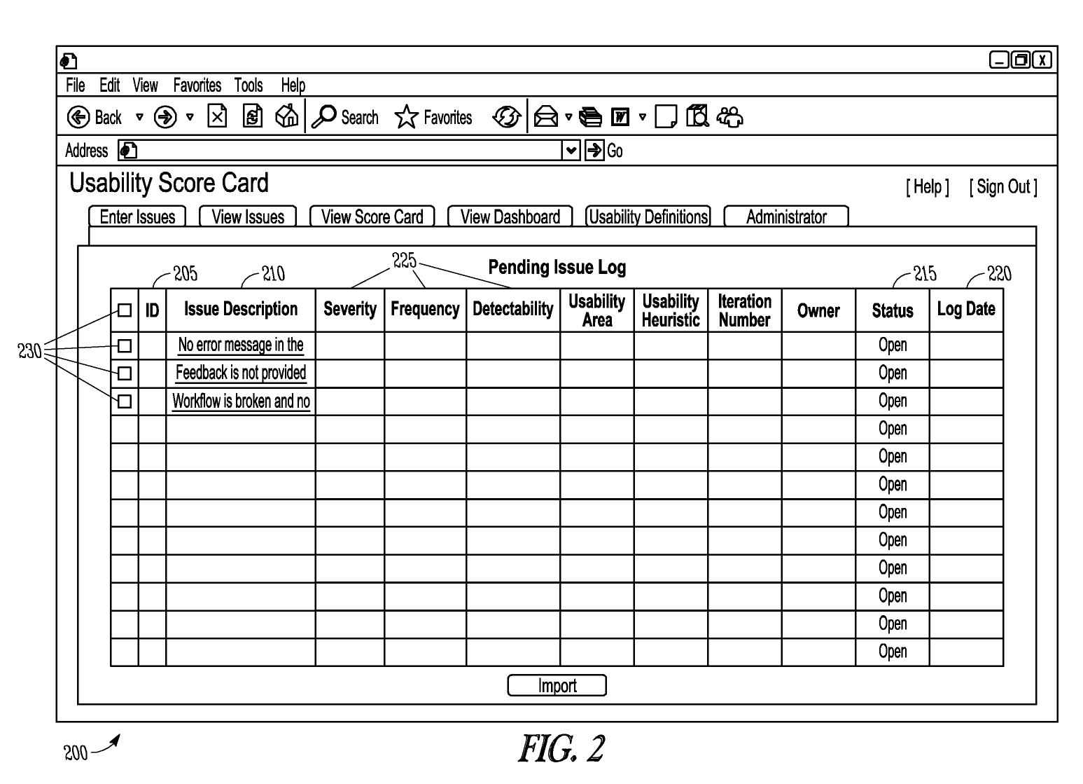

FIG. 2 is a screen shot of an example interface 200 showing an issue log with issues identified 205 with descriptive text 210 with hyperlinks to allow data to be edited. The hyperlinks may also provide for easy navigation to interface 100 for the corresponding issue. Interface 200 provides a convenient interface for keeping track of the issues and provide quick access to update scores for an interface that may have changed with a new version of the product. Interface 200 may provide information about the issue, such as the status 215, and corresponding log dates 220 and scores 225. A check box 230 may be provided for performing actions with respect to each issue, such as deleting the issue.

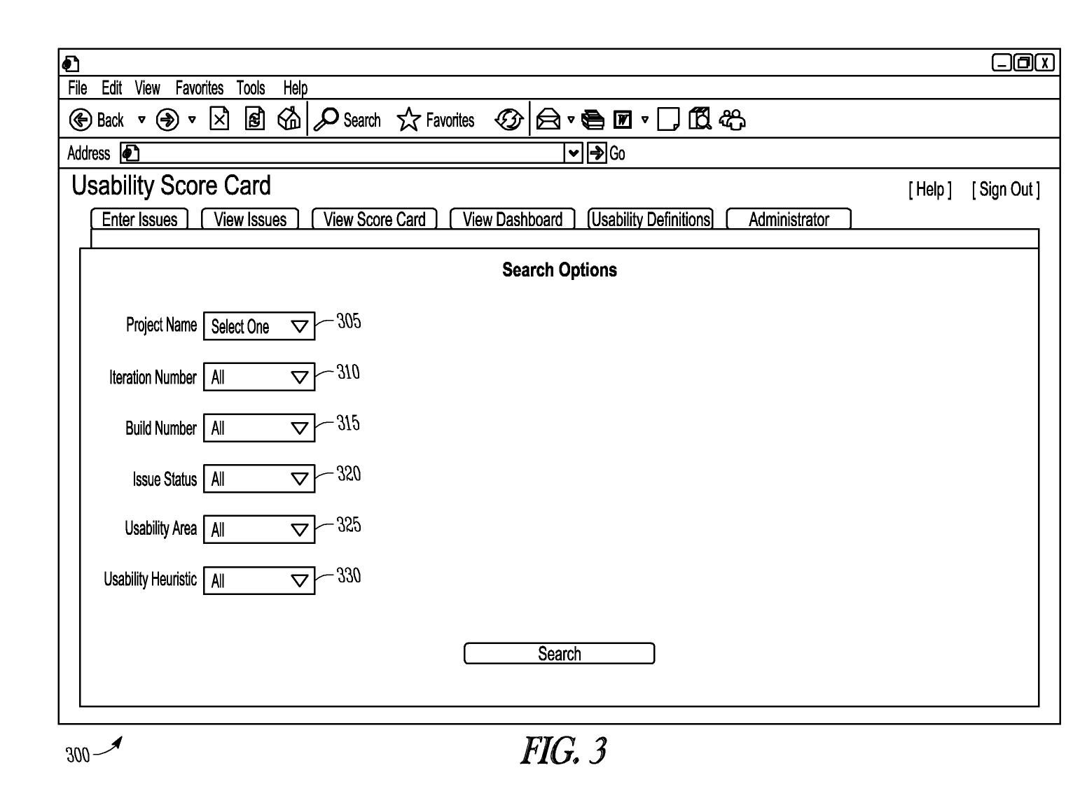

FIG. 3 illustrates an example administrator interface 300, providing search options to find projects 305, iterations 310, build numbers 315, issue status 320, usability area 325, and user heuristic 330. These search options, and others if desired allow different views of the usability scores for one or more products. It can be used to show all the open issues, or all the open issues in a certain usability areas among other views of the usability data. Such views of the data may facilitate management of work on a user interface of a product. Further, the system need not be limited to user interfaces. It may also be used to track progress in just about any type of process, such as manufacturing or general product design and development that has a hierarchy of metrics. The heuristics may be modified as desired to fit the requirements of the process, while still retaining the overall framework for identifying issues and evaluating them in accordance with measures appropriate for the process.

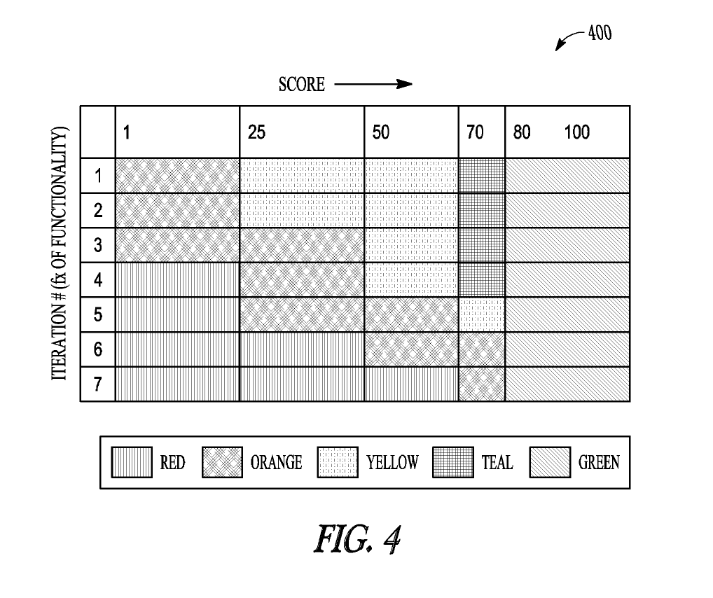

In one embodiment, the score is provided on a scale of 1-100, with a score of 80-100 being deemed high level usability that may be accepted as is. A score of 50-79 indicates medium level usability that requires revisions. A score of 1-49 indicates low level usability that requires significant changes. The scores may be color coded in one embodiment, as shown in a chart 400 in FIG. 4 with red corresponding to low level usability, yellow or orange corresponding to medium, light green or teal corresponding to medium high, and green corresponding to high. In one embodiment, the colors may reflect a version level of the user interface. For example, a score of 40 on a first version may be represented as medium level usability, as high scores may not be expected in a first version, but the corresponding product is on track for completion with continued revisions. This type of representation may be shown at an issue level, an area level, or overall score level, and provides a better indication of the state of the user interface relative to the version of the interface. For instance, using this sliding color scale, referred to as providing control limits, if the score were below 50, the color of the issue need not be red, but may be a color that provides a better indication of the usability at the corresponding stage of development.

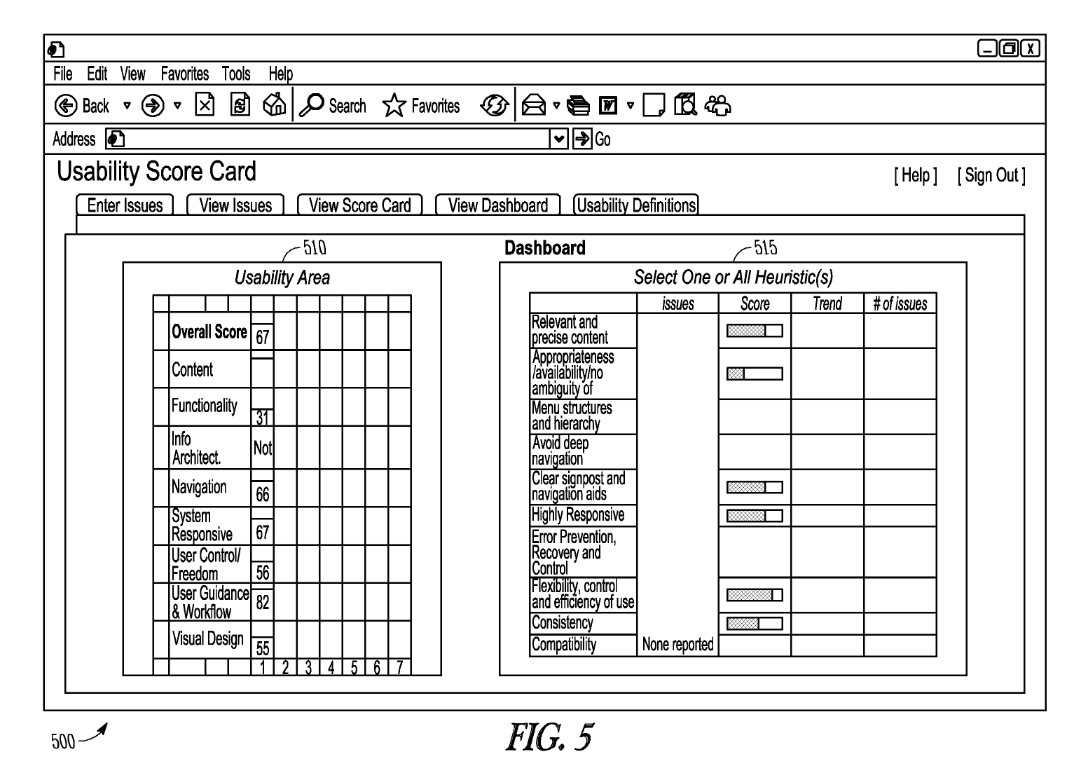

FIG. 5 illustrates a dashboard view interface 500 that shows the current score for each area on the left at 510, and scores for each heuristic on the right side 515 of the interface 500. Each heuristic may also have a trend indication, and a number of issues associated with the heuristic.

The dimensions associated with an issue in one embodiment are now described in further detail. Risk severity may be scored in one embodiment as a 1 if the issue is minor irritant, 3 if it is a major issue, and 9 if it is deemed fatal to the product. The probability of detection of an issue may be scored 1 if it occurs rarely, 3 if it occurs sometimes, and 9 if it occurs very frequently. The probability of occurrence of an issue may be scored 1 if it is easy to detect and is directly visible on an interface, 3 if it is difficult to detect and is buried in the interface, and 9 if the problem is unnoticed.

Example areas and the heuristic used to score issues within them are now described in further detail. Access may be evaluated based on whether easy and quick access is provided to required functionality and features. The content should be relevant and precise. Functionality should not be ambiguous and should be appropriate, available, and useful to a user. Navigation may be scored on the avoidance of deep navigation along with appropriate signs, and visual cues for navigation and orientation. The system should provide visible and understandable elements that help a user become oriented within the system and help users efficiently navigate forwards and backwards.

Organization may be scored on the state of the menu structures and hierarchy, as well as the overall organization of a home screen layout. The menu structures should match with a user's mental model of the product and should be intuitive and easy to use. The home screen should provide the user with a clear image of the system and provide direct access to key features. System bugs and defects are simply measured against a goal of no bugs and defects. System responsiveness may be measured to ensure the system is highly responsive. Goals in delays may be established, such as sub-second response times for simple features. Terminology should consist of informative titles, labels, prompts, messages and tool-tips.

User control and freedom may be measured based on error prevention, recovery and control, and flexibility, control and efficiency of use. Accelerators for expert users should be provided to speed up system interaction. User guidance and workflow support may be a function of compatibility, consistency with standards, providing informative feedback and status indicators, recognition rather than recall, help and documentation and work flow support. Visual design may be based on a subjective measure of being aesthetically pleasing, format, layout, spacing, grouping and arrangement, legibility and readability, and meaningful schematics, pictures, icons and color.

The basis for measurements in each of these areas may be modified in further embodiments, such as to tailor the measures for particular products or expected users of the products. The above measures are just one example. Descriptions of these areas and corresponding measures may be provided in the user interfaces of the system such as by links and drop down displays to aid the user and maintain consistent use of the measures.

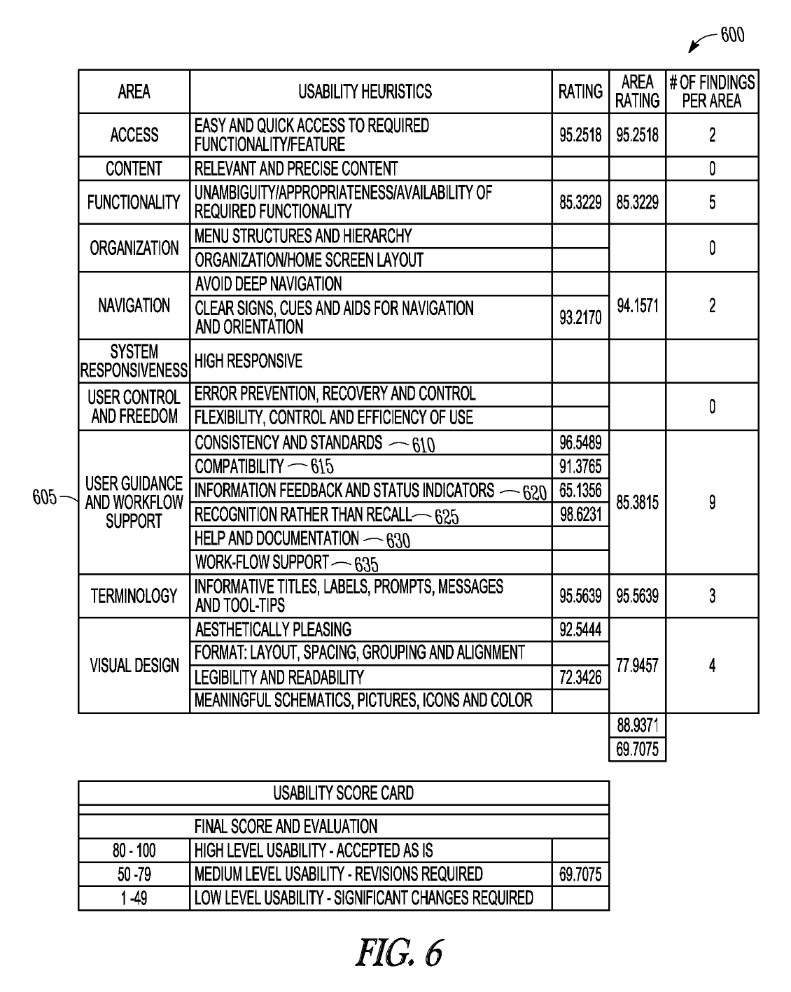

Example usability scores for a hypothetical product interface are illustrated in FIG. 6 in table form at 600. In some embodiments, graphs may be used to provide graphical views of data captured and processed by the system. The table and graphs may be used to illustrate the scores for areas of the product interface, along with the number of findings or issues per area. The user guidance and workflow support area 605 had nine findings, divided between sub-areas of consistency and support 610, compatibility 615, informative feedback and status indicators 620, recognition rather than recall 625, help and documentation 630, and work-flow support 635. The overall score for this area was 85.3815. Visual design had a score of 77.946 indicative of a need for further work. The overall score, when weighted based on the ratio of findings came in at 69.7075, indicative that the interface needs work.

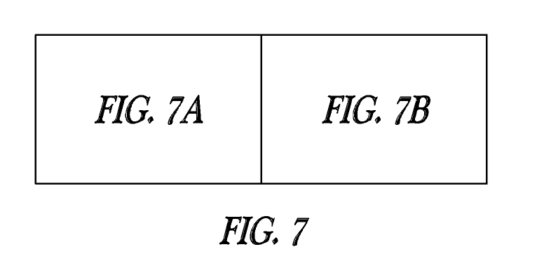

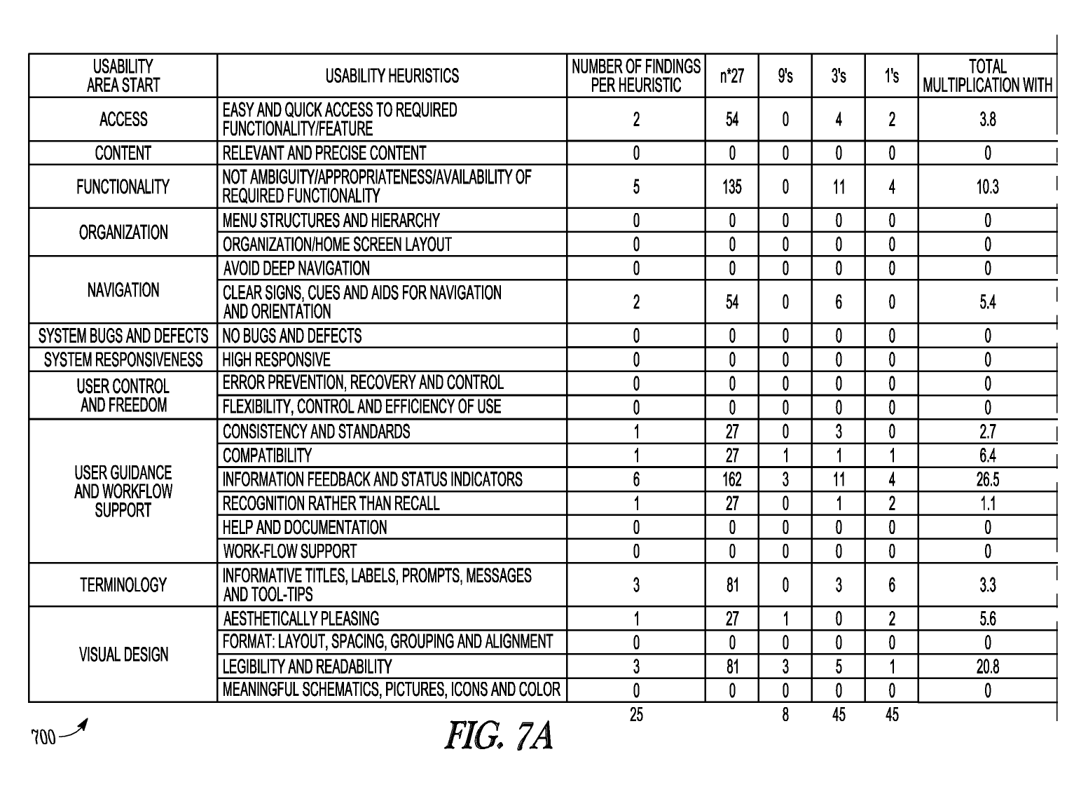

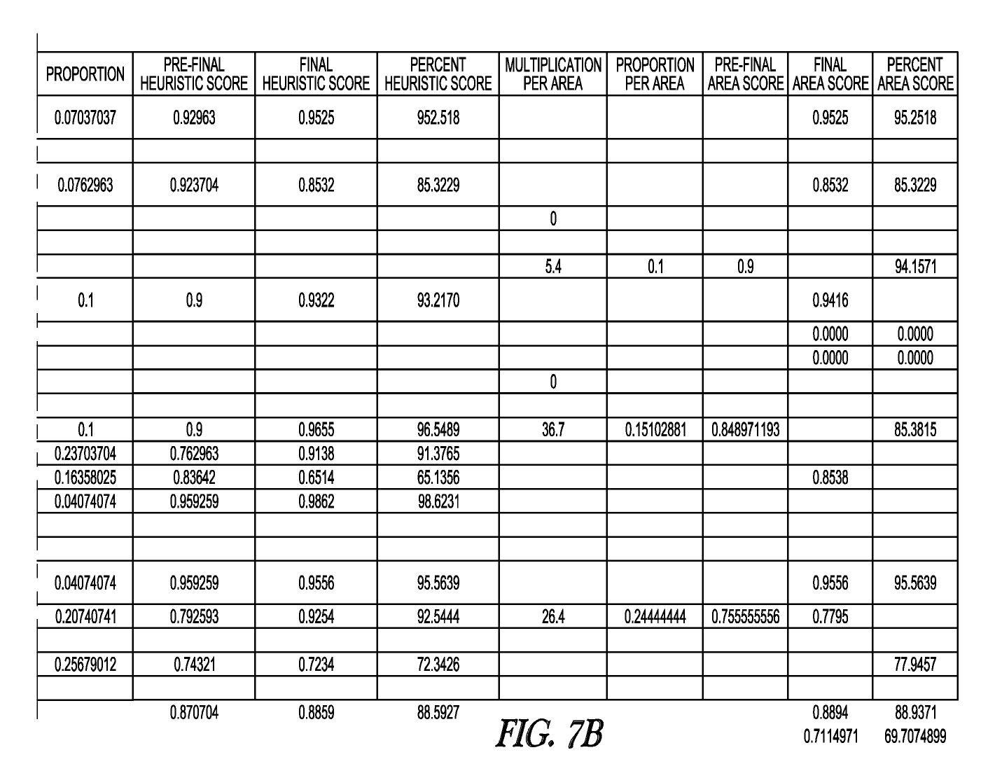

FIG. 7A is a block diagram showing an arrangement of FIGS. 7B and 7C to form a table 700 showing the actual scores for the issues and intermediate calculation values along with final scores. Note that the number of scores of 9, 3 and 1 are indicated for each area. For example the access area had no 9's, four 3's, and two 1's, resulting in an area score of 95.2518.

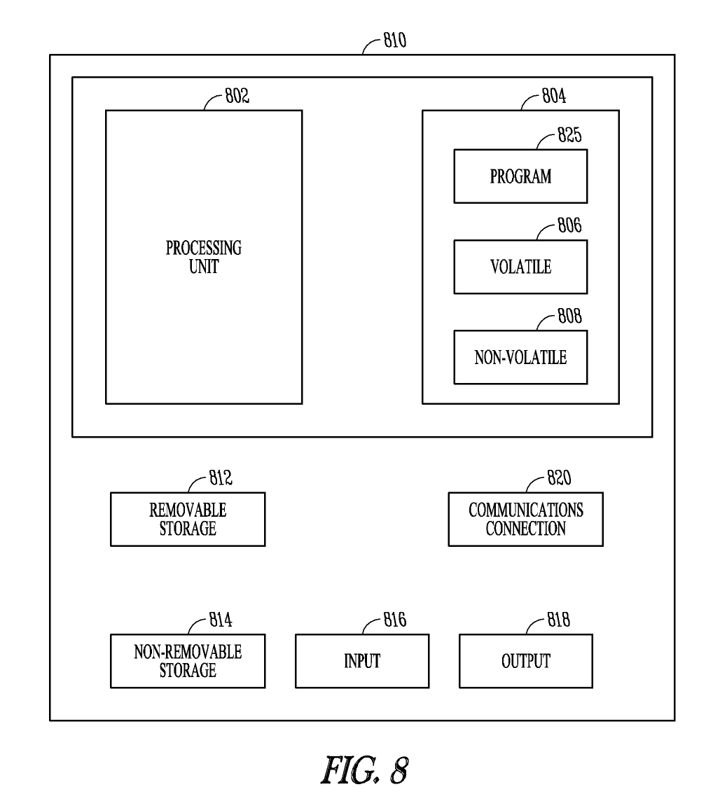

A block diagram of a computer system that executes programming 825 for performing the above algorithm and providing the user interface for entering scores is shown in FIG. 8. The programming may be written in one of many languages, such as virtual basic, Java and others. A general computing device in the form of a computer 810, may include a processing unit 802, memory 804, removable storage 812, and non-removable storage 814. Memory 804 may include volatile memory 806 and non-volatile memory 808. Computer 810 may include—or have access to a computing environment that includes—a variety of computer-readable media, such as volatile memory 806 and non-volatile memory 808, removable storage 812 and non-removable storage 814. Computer storage includes random access memory (RAM), read only memory (ROM), erasable programmable read-only memory (EPROM) & electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 810 may include or have access to a computing environment that includes input 816, output 818, and a communication connection 820. The input 816 may be a keyboard and mouse/touchpad, or other type of data input device, and the output 818 may be a display device or printer or other type of device to communicate information to a user. In one embodiment, a touchscreen device may be used as both an input and an output device.

The computer may operate in a networked environment using a communication connection to connect to one or more remote computers. The remote computer may include a personal computer (PC), server, router, network PC, a peer device or other common network node, or the like. The communication connection may include a Local Area Network (LAN), a Wide Area Network (WAN) or other networks.

Computer-readable instructions stored on a computer-readable medium are executable by the processing unit 802 of the computer 810. A hard drive, CD-ROM, and RAM are some examples of articles including a computer-readable medium.

The Abstract is provided to comply with 37 C.F.R. §1.72(b) is submitted with the understanding that it will not be used to interpret or limit the scope or meaning of the claims.

1. A system comprising:
a data entry device to enter data related to usability of a user interface of a product;
a processor to provide a usability score card on the data entry device, the score card facilitating entry of usability issues regarding the user interface, and entry of data related to three dimensions of each issue including a risk severity, a probability of occurrence of the issue, and a probability of detecting the issue, wherein the processor processes the data to provide an overall usability score of the user interface.

2. The system of claim 1 wherein entry of the data related to three dimensions includes assigning a rating to each dimension.

3. The system of claim 2 wherein the rating is a number corresponding to whether the dimension is considered by a user to be a minor irritant, a major issue, or a fatal issue.

4. The system of claim 3 wherein the ratings are weighted as a function of the severity of the issue.

5. The system of claim 3 wherein the ratings for risk severity, probability of occurrence of the issue, and probability of detecting the issue are equally weighted.

6. The system of claim 1 wherein dimension data is associated with a version of the product.

7. The system of claim 6 and further comprising processing dimension data for a usability issue across multiple versions to provide a history of usability scores for the usability issue.

8. The system of claim 7 wherein the usability score is correlated to a product development cycle.

9. The system of claim 8 wherein the usability score is correlated to the product development cycle to highlight usability scores that are low in comparison to a desired score at each time point in the product development cycle.

10. The system of claim 1 wherein the usability score card provides for entry of data over multiple usability issues over multiple areas of the user interface of the product.

11. The system of claim 1 wherein the user interface comprises multiple screens on a display device and the usability score is normalized as a function of a ratio of the number of issues to the number of screens in the user interface.

12. A method comprising:
receiving data related to usability of a user interface of a product;
providing a usability score card on the data entry device via a specifically programmed processor, the score card facilitating entry of usability issues regarding the user interface, and entry of data related to three dimensions of each issue including a risk severity, a probability of occurrence of the issue, a probability of detecting the issue; and
processing the data via the processor to provide an overall usability score of the user interface.

13. The method of claim 12 wherein entry of the data related to three dimensions includes assigning a rating to each dimension.

14. The method of claim 13 wherein the rating is a number corresponding to whether the dimension is considered by a user to be a minor irritant, a major issue, or a fatal issue.

15. The method of claim 14 wherein the ratings are weighted as a function of the severity of the issue.

16. The method of claim 14 wherein the ratings for risk severity, probability of occurrence of the issue, and probability of detecting the issue are equally weighted.

17. The method of claim 12 wherein dimension data is associated with a version of the product.

18. A computer readable device having a program stored thereon to cause a computer system to perform a method, the method comprising:
receiving data related to usability of a user interface of a product;
providing a usability score card on the data entry device via a specifically programmed processor, the score card facilitating entry of usability issues regarding the user interface, and entry of data related to three dimensions of each issue including a risk severity, a probability of occurrence of the issue, a probability of detecting the issue; and
processing the data via the processor to provide an overall usability score of the user interface.

19. The device of claim 18 wherein the method implemented by the computer system further comprises processing dimension data for a usability issue across multiple versions to provide a history of usability scores for the usability issue, wherein the usability score is correlated to a product development cycle to highlight usability scores that are low in comparison to a desired score at each time point in the product development cycle.

20. The device of claim 18 wherein the user interface comprises multiple screens on a display device and the usability score is normalized as a function of a ratio of the number of issues to the number of screens in the user interface.
